(19) United States
(12) Patent Application Publication
(10) Pub. No.: US 2009/0113729 A1
(43) Pub. Date: May 7, 2009

(54) Hacksaw

(76) Inventor: Teng-Lung Chen, Taichung (TW)

Correspondence Address: Teng-Lung Chen, P.O. Box 2103, Taichung City, TW

(21) Appl. No.: 11/979,726

(22) Filed: Nov. 7, 2007

(51) Int. Cl. B27B 21/06

(52) U.S. Cl. 30/513

(57) ABSTRACT

A hacksaw includes grip handle, adjustable frame, and adjusting component; the grip handle contains a storage space to accommodate a locating mechanism; the locating mechanism is received in the storage space and thus in an outer cover by means of closing the outer cover pivoted to a bottom of the grip handle to facilitate easy mounting of a blade and easy adjusting the blade by means of the locating mechanism and the adjusting component; and the adjustable frame is capable of storage of spare blade.

### BACKGROUND OF THE INVENTION

(a) Field of the Invention

The present invention is related to a hacksaw, and more particularly, to one that is provided with a storage space and outer cover to easily receive a locating mechanism for fixing a blade as an integrated part of a grip handle and to easily change sawing angle of the blade.

(b) Description of the Prior Art

Referring to FIG. 7 for a schematic view of an improved structure of a hacksaw of the prior art, the hacksaw includes a grip handle 9 connected to one end of an adjustable frame 8 and connected to a locking member 91; the locking member 91 hooks upon one end of a blade and then is locked to one side of the grip handle 9 by means of a hooking portion 911; another end of the adjustable frame is pivoted with an adjusting member 81 to adjust tension of the blade so to pack against the blade for operation.

In practice, the blade of a conventional hacksaw can be easily loosening up and falling out place due to impacts against the hooking portion at work or being carried and prevent easy gripping at work to frustrate the work and result in poor work efficiency.

Furthermore, the adjusting member is pivoted to the adjustable frame to prevent from adjusting a working angle of the blade. Upon mounting the blade, it takes to fasten by rotation the adjusting member so to cause the blade to deflect by compromising the packing direction to make it difficult to use the hacksaw and even result in broken blade in serious case.

### SUMMARY OF THE INVENTION

The primary purpose of the present invention is to provide a hacksaw structure that is capable of solving the problems found with the prior art by taking advantage of a grip handle that is disposed with a storage space and an outer cover so to easily receive a locating mechanism in the storage space and in the outer cover to become an integral part of the grip handle for achieving the purpose of easy accommodation of the locating mechanism to prevent it from being easily falling out of place.

Another purpose of the present invention is to provide a hacksaw structure that allows easy mounting or change of a sawing angle of the blade to meet work requirements simply by loosening up a locking member or by having a first restoration member and a second restoration member to cause a first pull member and a second pull member to produce synchronous displacement.

Another purpose yet of the present invention is to provide a hacksaw structure that allows storage of spare blades by taking advantage of the storage space in the hacksaw adjustable frame to be fetched for replacement whenever the existing blade is worn out or broken.

To achieve these purposes, a hacksaw structure of the present invention includes a grip handle, an adjustable frame, and an adjusting component. The grip handle contains a storage space to accommodate a locating mechanism, and the locating mechanism is received in and closed up with an outer cover, which is pivoted to a bottom of the grip handle; the locating mechanism includes a connection rod provided with a longer end and shorter end, a passive member, an adjusting member, a first restoration member, and a first pull member, one end of the outer cover is pivoted to the shorter end of the connection rod and the longer end of the connection rod is pivoted to the passive member, and the connection rod strides over where the outer cover is pivoted to the grip handle; the passive member pivoted in the storage space of the grip handle is provided with a first locating hole containing different sizes of inner diameter to receive insertion of the adjusting member, the first restoration member, and the first pull member; the first locating hole also secures the first pull member; the outer cover closes upon a bottom of the grip handle in a direction facing the passive member and the connection rod pulls the passive member for the passive member to rest in the storage space of the grip handle; and the storage space accommodates the connection rod, the adjusting member, and the first restoration member in the outer cover.

The adjustable frame is provided with a horizontal section and a vertical section with the former secured to the grip handle and arranged in approximately parallel with the outer cover.

The adjusting component includes a fixation member, a second restoration member, a second pull member, and a locking member secured to the vertical section of the adjustable frame; the fixation member is provided with a second locating hole in different sizes of inner diameter and arranged in approximate in a straight line with the first locating hole; the second pull member penetrates through the second restoration member and secured in the second locating hole to secure the second pull member by means of the locating member.

### BRIEF DESCRIPTION OF THE DRAWINGS

FIG. 1 is a perspective view of a preferred embodiment of the present invention.

FIG. 2 is an exploded view describing relationship among all members of the preferred embodiment of the present invention.

FIG. 3 is a sectional view describing a structure of a storage space and an outer cover in its extended status of the preferred embodiment of the present invention.

FIG. 4 is another sectional view of the preferred embodiment of the present invention describing a state of mounting a blade.

FIG. 5 is a schematic view showing conversion of angle of the blade of the preferred embodiment of the present invention.

FIG. 6A is a sectional view showing a grip handle is connected with an adjustable frame in the preferred embodiment of the present invention.

FIG. 6B is a schematic view showing that a press member is subject to a compressed status in the preferred embodiment of the present invention.

FIG. 7 is a schematic view of a hacksaw of the prior art.

### DETAILED DESCRIPTION OF THE PREFERRED EMBODIMENTS

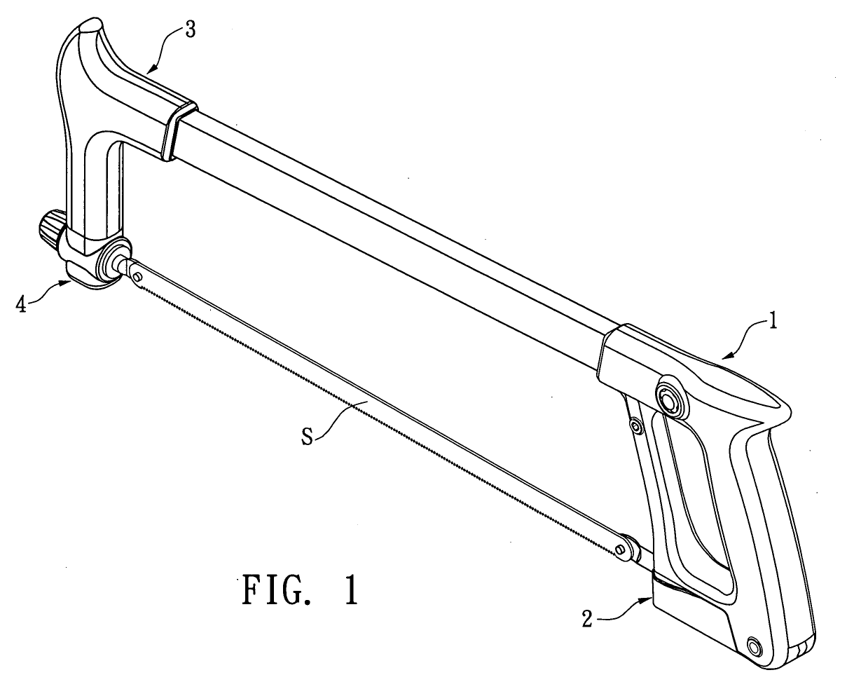

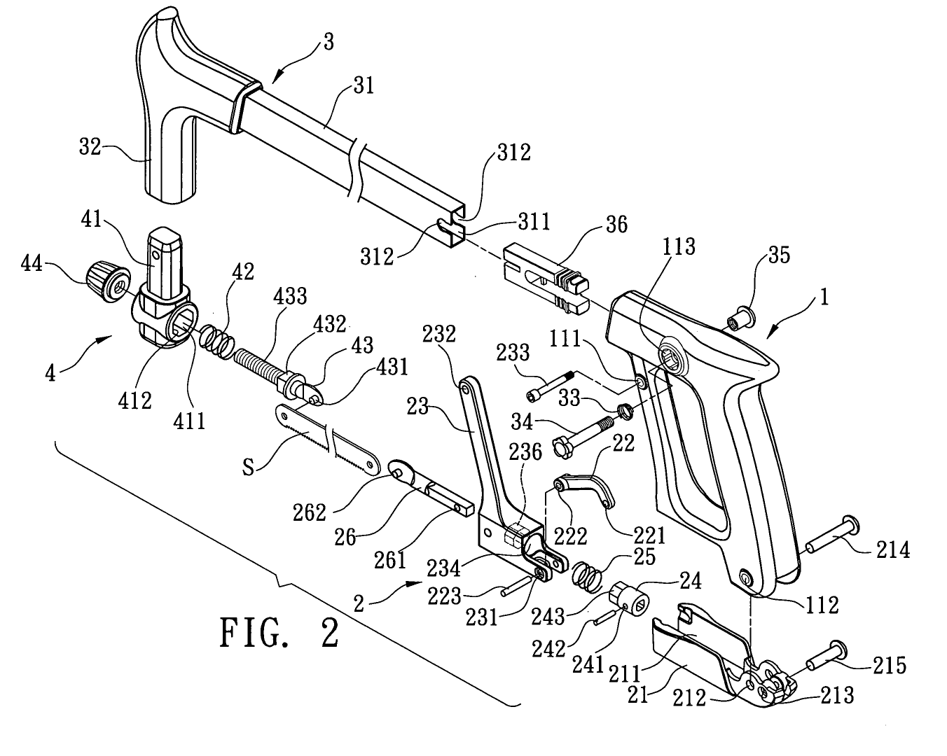

Referring to FIGS. 1 through 4 for a preferred embodiment of the present invention, a hacksaw structure is essentially comprised of a grip handle 1, a locating mechanism 2, an adjustable frame 3, and an adjusting component 4.

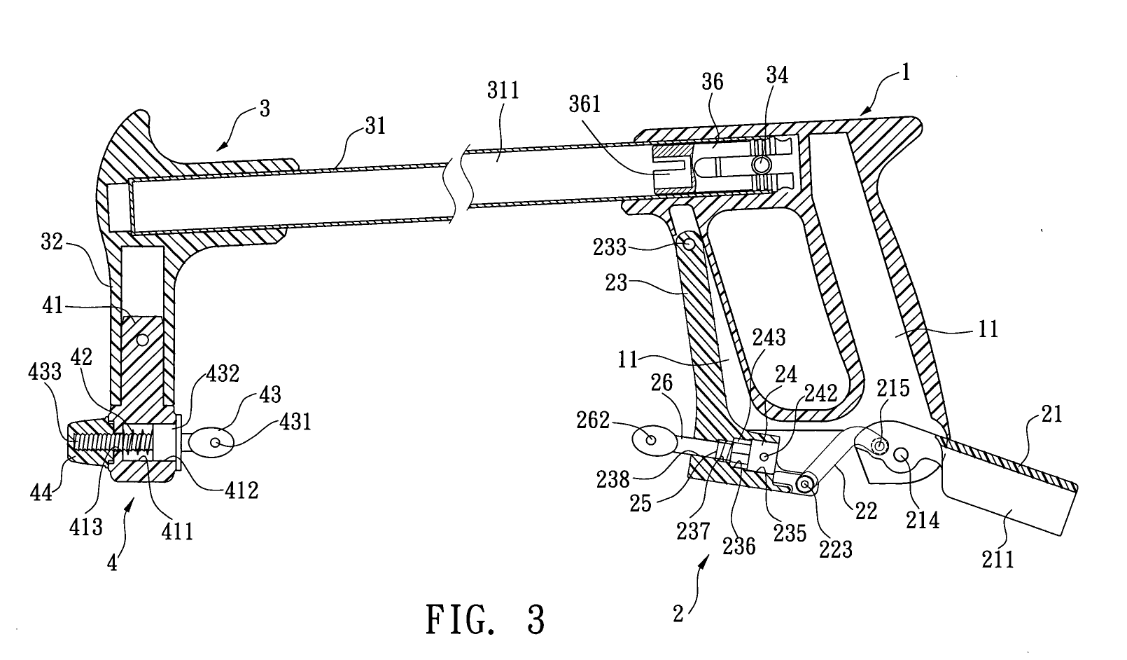

The grip handle 1 contains a storage space 11 for accommodating the locating mechanism 2 as detailed in FIG. 3. The locating mechanism 2 may be closed in by an outer cover 21 pivoted to a bottom of the grip handle 1 for the locating mechanism 2 to be received in the storage space 11 and the outer cover 21.

The locating mechanism 2 includes a connection rod 22 provided with a shorter end and a longer end, a passive member 23, an adjusting member 24, a first restoration member 25, and a first pull member 26. In the preferred embodiment, the first restoration member 25 is related to a spring. The storage space 11 in the grip handle 1 is provided with a pair of upper pivoting holes 111 and a pair of lower pivoting holes 112; a fixation hole 113 is disposed on an upper end of the grip handle; the outer cover 21 contains a closing up space 211 with one end provided in sequence a pair of front pivoting holes 212 and a pair of rear pivoting holes 213; and the outer cover 21 is pivoted to both lower pivoting holes 112 by inserting a pin 214 into both front pivoting holes 212. The connection rod 22 roughly indicates an L shape with its shorter end pivoted to the outer cover 21 by inserting a pin 215 through a pivoting hole 221 disposed on the shorter end through both rear pivoting holes 213 of the outer cover 21 by inserting a pin 215 into both rear pivoting holes 213 of the outer cover 21 and the longer end of the connection rod 22 is also provided with a pivoting hole 222, a pin 223 penetrates the pivoting hole 222 to pivot the longer end of the connection rod 22 by passing through a pair of the first pivoting holes 231 disposed on a lower end of the passive member 23 so that for the connection rod 22 to cross over where the outer cover 21 and the grip handle 1 are pivoted to each other. An upper end of the passive member 23 is pivoted in the upper pivoting hole 111 in the storage space 11 of the grip handle 1 by inserting a pin 233 through a second pivoting hole 232; and a first locating hole 234 is disposed on a bottom of the passive member 23 containing different sizes of inner diameter. Depending on the size of the inner diameter, the first locating hole 234 is divided into a larger diameter section 235, a first locating section 236, a mid-diameter section 237, and a small diameter section 238 as illustrated in FIG. 3. The first pull member 26 contains a fixation hole 261 and a protruding post 262 with one end of the locating hole 261 passing through the small diameter section 238, the mid diameter section 237, the first restoration member 25, the first locating section 236, and the adjusting member 24. A pin 242 is inserted into a hole 241 provided on an outer side of the adjusting member 24 to pass through a fixation hole 261 disposed on the first pull member 26 to secure both of the adjusting member 24 and the first pull member 26. The adjusting member 24 holds against the locating hole 234 by means of the first restoration member 25; and the first locating section 236 of the locating hole 234 and the first adjusting section 243 of the adjusting member 24 are locked to each other. Both of the first locating section 236 and the first adjusting section 243 are each disposed with multiple planes and a regular octagon in this preferred embodiment that allows locating with another regular octagon. The first pull member 26 is secured in the first locating hole 234 by the first locating section 236 and the adjusting member 24 to prevent the first pull member from rotating inside the first locating hole 234.

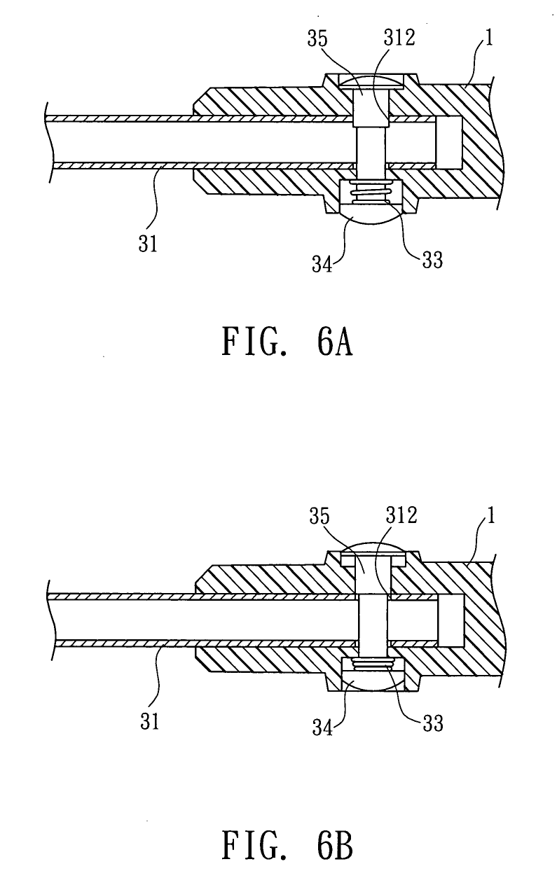

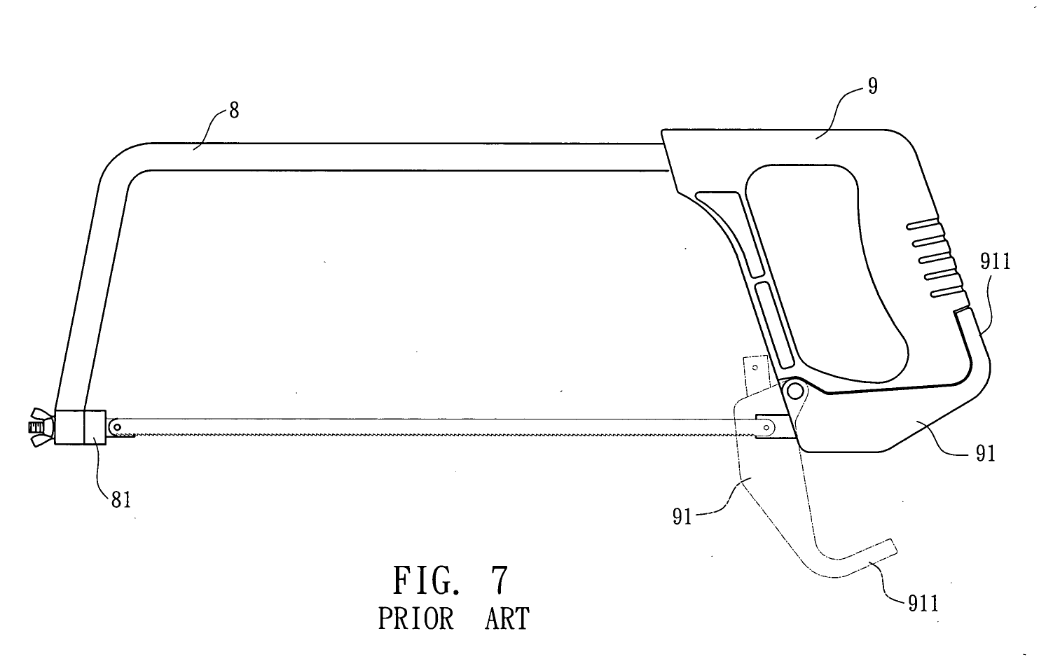

The adjustable frame 3 is provided with a horizontal section 31 and a vertical section 32. The horizontal section 31 of the adjustable frame 3 is related to an hollow structure containing a storage space 311 with an opening end of the storage space 311 containing a fixation slot 312; and the fixation slot 312 penetrates through and rests in the locating hole 113 of the grip handle 1 as detailed in FIGS. 6A and 6B. A spring 33 externally disposed to the locating hole 113 of the grip handle 1 holds against a press member 34, which penetrates through the locating hole 113 and is fastened by a retaining nut 35. The retaining nut 35 retains the press member 34 in the fixation slot 312 so to take advantage of having the spring 33 to hold against the press member 34 for the retaining nut 35 to be locked in the fixation slot 312 of the adjustable frame 3 to further secure the grip handle 1 and the adjustable frame 3. A fixation block 36 is further secured in the storage space 311. The fixation block 36 is locked in the storage space 311 and a locking slot 361 disposed at one end of the fixation block 36 secures a spare blade in place.

The adjusting component 4 includes a fixation member 41 secured to the vertical section 32 of the adjustable frame 3, a second restoration member 43, a second pull member 43, and a locking member 44. In the preferred embodiment, the second restoration member 42 is related to a spring. The locating member 41 contains a second locating hole 411 in different sizes of inner diameter and is arranged in approximately indicating a straight line with the first locating hole 234. The second locating hole 411 depending on the size of its inner diameter is divided into a second locating section 412 and a retaining section 413. The second pull member 43 is disposed with a protruding post 431, a second adjusting section 432, and a locking section 433. The second pull member 43 penetrates through the second restoration member 42 and the second locating hole 411 to lock the locking section 433 of the second pull member 43 by means of the locating member 44 and take advantage of the retaining section 413 of the second locating hole 411 to resist the second restoration member 42 for holding against the second pull member. Each of both of the second locating section 412 and the second adjusting section 432 is provided with multiple planes, and respectively provided in an octagon and a tetragon in the preferred embodiment, that can be locked to each other to secure in place so to prevent the second pull member 43 from rotating in the second location hole 411.

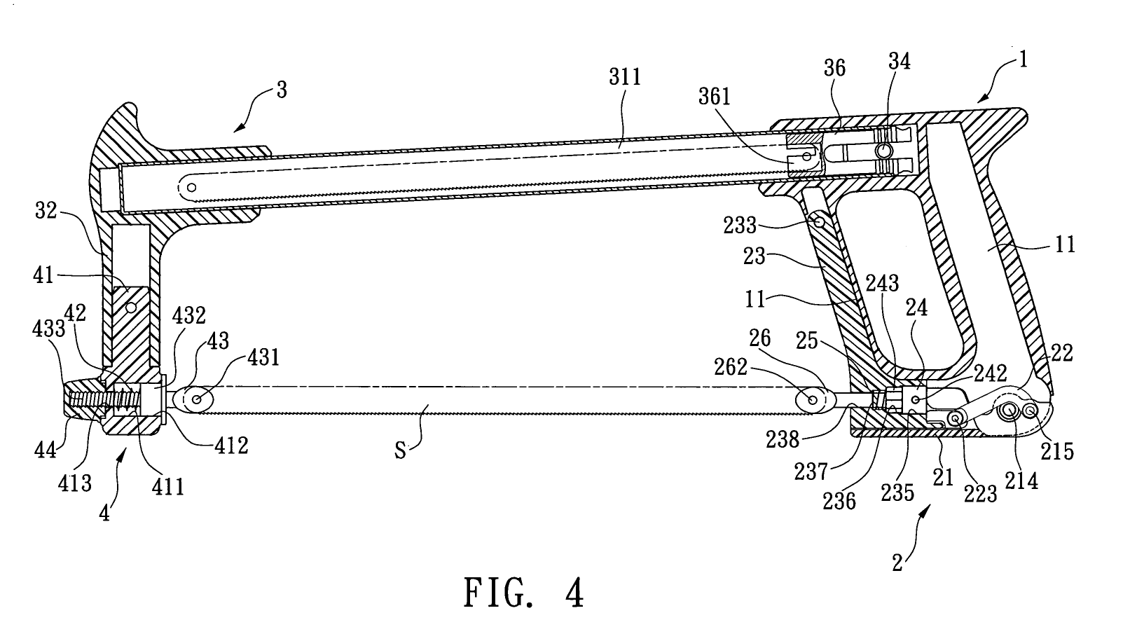

Now referring to FIGS. 3 and 4, upon mounting a blade, the outer cover 21 is pulled backward while having the pin 214 pivoted to the grip handle 1 as an axis the outer cover 21 rotates to push the connection rod 22 to hold against the passive member for the passive member 23 to outward move from the storage space 11 of the grip handle 1. Accordingly, a gap between protruding posts 262 and 431 of the first pull member 26 and the second pull member 43 is changed to facilitate mounting the blade.

On the contrary, upon completing installation of a blade S, the outer cover 21 is pulled in a direction facing the passive member 23 to close upon the bottom of the grip handle 1 while the connection rod 22 pulls the passive member 23 to rest the passive member 23 in the storage space 11 of the grip handle 1 and to receive the connection rod 22, the adjusting member 24, and the first restoration member 25 in the storage space 11, thus in the outer cover to further locate the first pull member 26 and to cause the outer cover 21 to be at where approximately in parallel with the horizontal section of the adjustable frame 3.

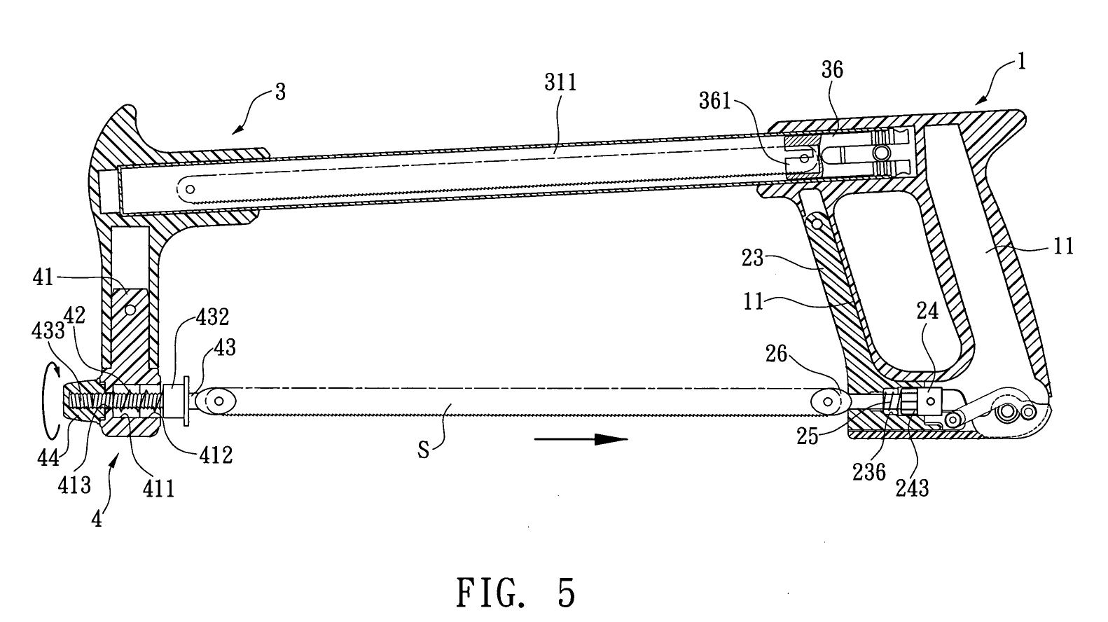

As illustrated in FIG. 5 describing a relation of converting a sawing angle of the blade, upon slightly loosening up the locating member 44, elasticity exerted by the second restoration member 42 and the first restoration member 25 will eject the second pull member 43 and adjusting member 24, and to cause the second adjusting section 432 of the second pull member 33 to disengage from the second locating section 412 while disengaging the first adjusting section 243 of the adjusting member 24 from the first locating section 236 of the passive member 23. Therefore, it takes only to readjust the sawing angle of the blade S to a proper location before fastening the locking member 44 to pack for locating the blade S for further sawing operation. The locking slot 316 disposed to the fixation block 36 may be borrowed for securing a spare blade in the storage space 311 of the horizontal section 31 of the adjustable frame 3.

As illustrated in FIGS. 6A and 6B showing a relation of being locked to secure in place and released between the adjustable frame 3 and the grip handle 1, when both of the adjustable frame 3 and the grip handle 1 are secured to each other, it is achieved by borrowing elasticity exerted by the spring 33 to cause the retaining nut 35 to be locked and secured in the fixation slot 312 of the horizontal section of the adjustable frame 3 to become an integrated hacksaw. Upon applying force on the press member 34, the spring 33 is compressed for the retaining nut 35 to outward move for causing the retaining nut 35 to disengage from the fixation slot 312 of the adjustable frame 3 thus to separate both of the grip handle 1 and the adjustable frame from each other.

Accordingly, by taking advantage of a grip handle provided with a storage space and an outer cover, the present invention easily receive a locating mechanism in the storage space and thus in the outer cover to become an integrated part for achieving the purpose of easy storage of the locating mechanism and preventing it from being easily fall out of place.

When setting up or converting a sawing angle of a blade, it takes only to loosen up a locking member and take advantage of a first restoration member and a second restoration member to cause a first pull member and a second member to produce synchronous displacement.

Furthermore, a storage space disposed in the adjustable frame may receive a spare blade to be fetched whenever the existing blade is worn out or broken.

I claim:

1. An improved structure of a hacksaw comprising:
a grip handle containing a storage space to accommodate a locating mechanism, the locating mechanism being closed in an outer cover pivoted to a bottom of the grip handle and received in the storage space and thus in the outer cover, the locating mechanism comprising a connection rod disposed with a shorter end and a longer end, a passive member, an adjusting member, a first restoration member, and a first pull member, one end of the outer cover being pivoted to the shorter end of the connection rod, the longer end of the connection rod being pivoted to the passive member, the connection rod striding over where the outer cover and the grip handle are pivoted to each other, the passive member being pivoted in the storage space of the grip handle, the passive member containing a first locating hole, the first locating hole containing different size of inner diameter, the adjusting member, the first restoration member, and the first pull member being disposed in the first locating hole, the first locating hole securing the first pull member in place, the outer cover closing upon the bottom of the grip handle in a direction facing the passive member, the passive member being pulled by the connection rod to rest in the storage space of the grip handle, and the storage space receiving the connection rod, the adjusting member, and the first restoration member in the outer cover;
an adjustable frame disposed with a horizontal section and a vertical section with the horizontal section fixed to the grip handle and arranged approximately in parallel with the outer cover; and
an adjusting component containing a fixation member secured to the vertical section, a second restoration member, a second pull member, and a locking member, the locating member containing a second locating hole, the second locating hole contains different sizes of inner diameter and being arranged in approximately indicating a straight line with the first locating hole, the second pull member penetrating through the second restoration member and secured in the second locating hole; and the second pull member is secured in place by means of the locking member.

2. The improved structure of a hacksaw as claimed in claim 1, wherein the first locating hole is divided by the size of the inner diameter into a large diameter section, a first locating section, a mid diameter section, and a small diameter section in sequence; the first pull member penetrates through the small diameter section, the mid diameter section, and the first restoration member; the first restoration is secured to the adjusting member by means of a pin; a first adjusting section of the adjusting member is secured in the first locating section and secures the first pull member in place for the first pull member to be secured in the first locating hole; the second locating hole is divided depending on the size of the inner diameter into a second locating section and retaining section in sequence; the second pull member penetrates through the second restoration member and secured in the second locating hole; the second adjusting section disposed on the second pull member secures the second member in the second locating section; and the second pull member is fixed in place by means of the locking member.

3. The improved structure of a hacksaw as claimed in claim 2, wherein both of the first locating section and the first adjusting section are each disposed with multiple planes and are locked to each other to secure in place.

4. The improved structure of a hacksaw as claimed in claim 2, wherein both of the second locating section and the second adjusting section are each disposed with multiple planes and are locked to each other to secure in place.

5. The improved structure of a hacksaw as claimed in claim 1, wherein the horizontal section of the adjustable frame is related to a hollow structure containing a storage space; an opening of the storage space is disposed with a fixation slot; a fixation hole is disposed to the grip handle, a spring outside the fixation hole holds against a press member; the press member penetrates through the fixation hole and is secured by means of a locking member; and the spring holding against the press member causes the locking member to be locked and secured in the fixation slot of the adjustable frame.

6. The improved structure of a hacksaw as claimed in claim 5, wherein a fixation block is further disposed in the storage space to secure a blade.

7. The improved structure of a hacksaw as claimed in claim 1, wherein the first and the second restoration member are respectively related to a spring.

8. The improved structure of a hacksaw as claimed in claim 1, wherein the connection rod roughly indicates an L shape.
